(19) United States
(12) Patent Application Publication
(10) Pub. No.: US 2007/0040135 A1
(43) Pub. Date: Feb. 22, 2007

(54) Surface safety systems actuator operated by electro-magnetic device

(76) Inventors: Dave Dyer, Aberdeen (GB); Henk Maatje, Drenthe (NL); Henk Weide, Drenthe (NL)

Correspondence Address: CANTOR COLBURN, LLP, 55 GRIFFIN ROAD SOUTH, BLOOMFIELD, CT, 06002, US

(21) Appl. No.: 11/350,441

(22) Filed: Feb. 9, 2006

Related U.S. Application Data
(60) Provisional application No. 60/651,530, filed on Feb. 9, 2005.

(51) Int. Cl. F16K 31/08

(52) U.S. Cl. 251/65; 251/129.1

(57) ABSTRACT

Disclosed herein is an electromagnetic valve actuator. The actuator includes a housing, a drive stem extending from the housing, and an electro-magnet in operable communication with the housing and drive stem, the drive stem being responsive to a magnetic field generated by the electromagnet. Further disclosed is an electro-magnetic-mechanical valve actuator. The actuator includes a housing, a drive stem having a stem head extending from the housing, a lead screw supported by the housing a motor in driving communication with the lead screw and a follower in threaded communication with the lead screw, the follower selectively electro-magnetically affixable to the stem head. Yet further disclosed herein is a method for operating a valve actuator. The method includes applying a current to an electromagnet to urge a drive stem against a closure spring to open a valve and maintaining current in the electro-magnet to keep the valve in the open position.

### CROSS REFERENCE TO RELATED APPLICATIONS

This application claims the benefit of an earlier filing date from U.S. Provisional Application Ser. No. 60/651,530 filed Feb. 9, 2006, the entire disclosure of which is incorporated herein by reference.

### BACKGROUND

In the hydrocarbon exploration and recovery industry, valves are required in great numbers and configurations. Commonly, the most critical valves are hydraulically controlled. This is because hydraulically controlled valves have been shown to be effective and reliable through the test of time. In order to ensure proper operation of such valves, many regulating bodies have elected to require that, inter alia, a volume of hydraulic fluid equal to three times that actually required to operate the valve(s) be kept on hand. Such a volume of fluid requires a large amount of storage space. Storage space on an oilrig is at a premium, thus making the use of the hydraulically controlled valves (when regulated) less desirable.

In addition to the foregoing, environmental regulatory authorities have recently begun implementing regulations directly restricting the use of hydraulic fluid. This of course makes the use of hydraulically actuated valves even more problematic.

Because of the foregoing, alternative means to actuate valves are welcomed by the art.

### SUMMARY

Disclosed herein is an electromagnetic valve actuator. The actuator includes a housing, a drive stem extending from the housing, and an electro-magnet in operable communication with the housing and drive stem, the drive stem being responsive to a magnetic field generated by the electro-magnet.

Further disclosed herein is an electro-magnetic-mechanical valve actuator. The actuator includes a housing, a drive stem having a stem head extending from the housing, a lead screw supported by the housing a motor in driving communication with the lead screw and a follower in threaded communication with the lead screw, the follower selectively electro-magnetically affixable to the stem head.

Yet further disclosed herein is a method for operating a valve actuator. The method includes applying a current to an electromagnet to urge a drive stem against a closure spring to open a valve and maintaining current in an electro-magnet to keep the valve in the open position.

### BRIEF DESCRIPTION OF THE DRAWINGS

Referring now to the drawings wherein like elements are numbered alike in the several Figures:

FIG. 1 is a schematic cross-sectional view of an electromagnetic actuator in a closed position;

FIG. 2 is a schematic cross-sectional view of the electromagnetic actuator of FIG. 1 in an open position;

FIG. 3 is a schematic cross-sectional view of an electromagnetic mechanical actuator in a closed position; and

FIG. 4 is a schematic cross-sectional view of the actuator of FIG. 3 in an open position.

### DETAILED DESCRIPTION

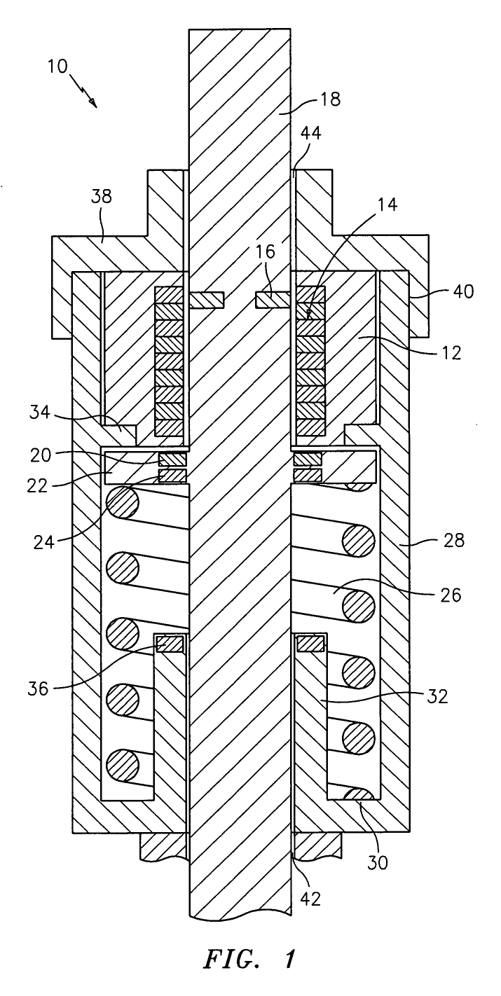

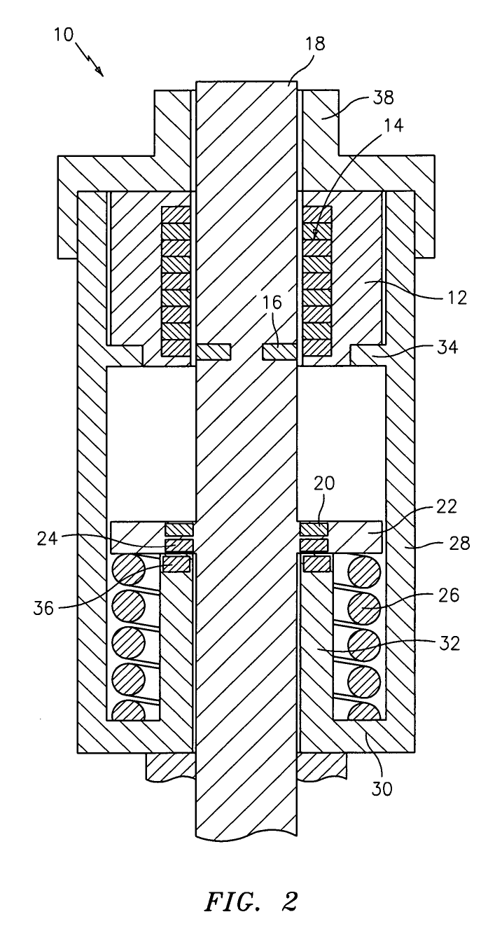

Referring to FIG. 1 an embodiment of an electromagnetic actuator 10 for an oil field valve is illustrated in cross-section. The actuator 10 is magnetically controllable based upon application of a current to a coil 12. Current applied to coil 12 results in a magnetic field generated about electromagnets 14. The field created thereby works to move a stator 16 at drive stem 18 in a directional manner toward an opposite end of the magnets 14 than depicted in FIG. 1 (see FIG. 2 position). The field created about magnets 14 also urges one or more magnets 20 away from magnets 14. Magnet(s) 20 may be permanent magnets or may be electro-magnets.

As is illustrated in the drawing FIG. 1, magnets 20 are mounted at a spring flange 22. The flange 22 is also home to additional one or more magnets 24, which likewise maybe permanent magnets or electro-magnets. Flange 22 is a part of drive stem 18 by integral formation or subsequent affixation. Flange 22 is in operable communication with a biasing member 26 such as a spring as shown. Spring 26 urges the flange such that the valve attains a closed position. Support for spring 26 is found in a housing 28, which bounds spring 26 between a lower housing 30 and the flange 22.

In the illustrated embodiment, housing 28 includes, relative to movement of flange 22 (and thereby drive stem 18), two discussed features. The first feature is a pedestal 32 that extends from the lower housing 30 toward flange 22 and the second is a flange stop 34 to stop flange movement at an appropriate stroke. Pedestal 32 supports a hold open magnet 36 which may be a permanent magnet or an electro-magnet providing that between the magnet(s) 24 and magnet(s) 36 at least one (set) is an electro-magnet to provide for selective magnetic field reversal and for fail safe functionality. These concepts will be discussed further hereunder.

Finally, housing 28 is mateable with actuator head 38. Although not specifically shown, it is intended that the actuator 10 be environmentally sealed at interface 40 between head 38 and housing 28 and additionally at bore 42 to drive stem 18 and bore 44 to drive stem 18. Environmental sealing may be accomplished in a number of ways including the use of O-rings as is well known to one of ordinary skill in the art.

The actuator 10 as described relies upon magnetic field generation to move from a closed position (FIG. 1) to an open position (FIG. 2). Primarily the coil 12 creates the initial magnetic field in magnets 14. That field urges stator 16 toward the open position (linear motor concept). This can be the sole opening force or may be supplemented by magnet(s) 20, 24 and 36 polarized to produce attractive fields. Where magnets 20, 24 and 36 are electromagnets, the attractive forces generatable and repulsive forces generatable provide selective polarity of either one of each cooperable magnet set (i.e., 20 and 14 or 24 and 36) and may be changed as desired to enhance operation of the system. It is also to be appreciated that the device is inherently fail-safe since if power is lost for any reason, the electromagnets immediately lose the magnetic field and the spring 26 (compressed by action of the magnetic fields) is free to act to move the actuator to the closed position shown in FIG. 1.

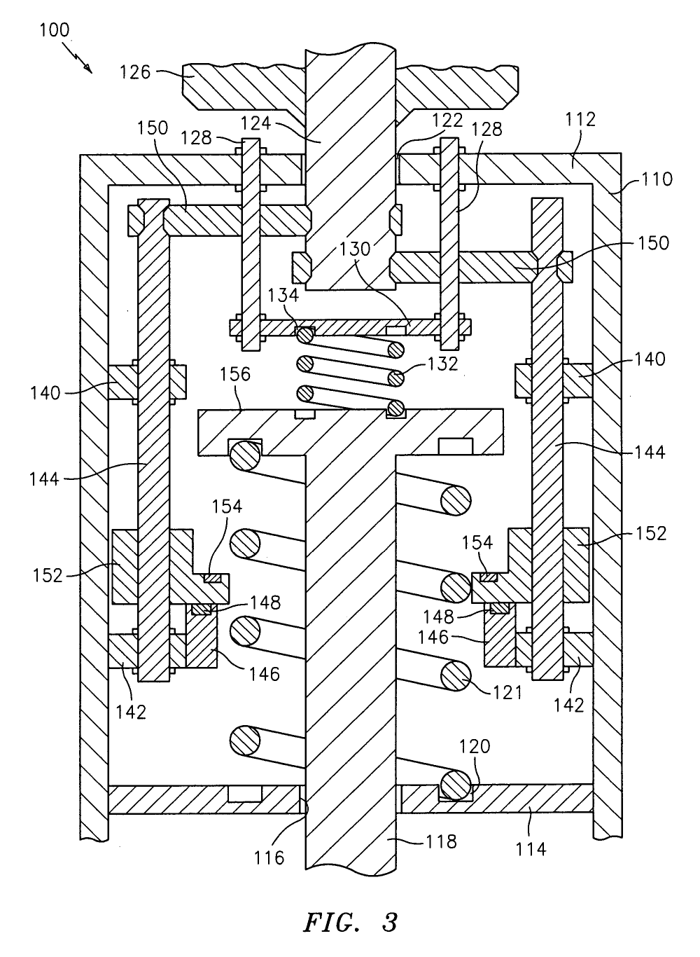

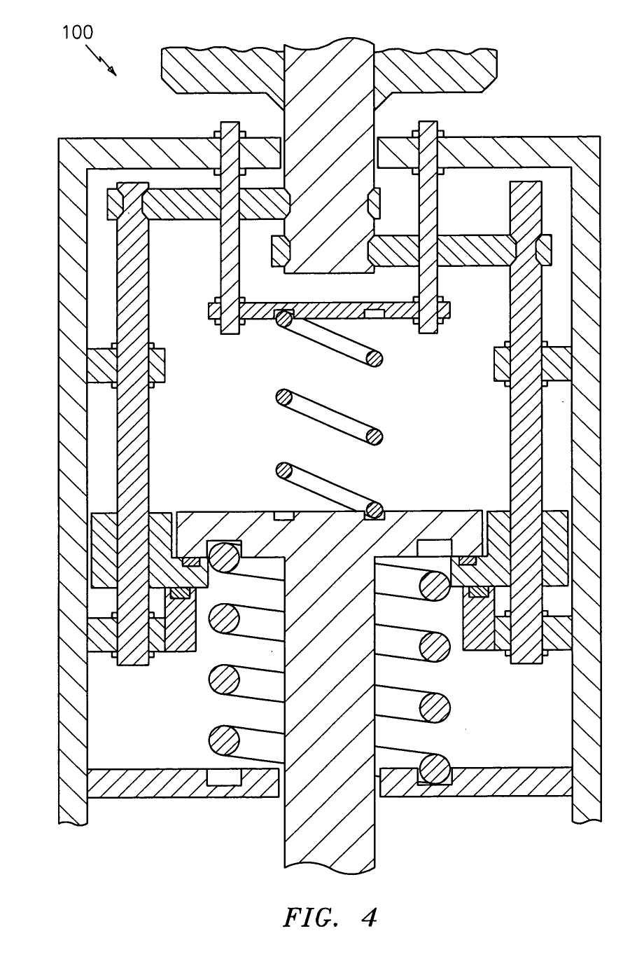

In another embodiment, referring to FIGS. 3 and 4 an electro-magnetic/mechanical actuator 100 is illustrated. The fail-safe benefit of the foregoing embodiment is maintained in this embodiment in that the open condition (FIG. 4) requires power supplied to an electro-magnet. Where power is lost to the actuator, it automatically moves to the closed position. Although the actuator disclosed hereunder is similar to the foregoing actuator, the components are each different enough to require distinct numerals. Therefore, 100 series numerals of the numerals used above are not intended to bear relation thereto.

Still referring to both of FIGS. 3 and 4, a housing 110 includes a first end cap 112 and a second end cap 114. The end caps are to be fixedly attached to housing 110 in a reliable manner, and in particular embodiments, in an environmentally sealed manner. End cap 114 includes a through bore 116 configured and dimensioned to receive a drive stem 118. End cap 114 also provides a spring seat 120 for a spring 121 which may be a coil spring as illustrated or may be another biasing member or arrangement.

End cap 112 includes an opening 122 for through passage of a drive shaft 124 from motor 126. End cap 112 also provides support for stanchions 128 which themselves support a stop 130 for buffer 132. In the illustrated embodiment buffer 132 is a coil spring but could be other arrangements capable of dampening the movement of the drive stem 118 in a closing action. Stop 130 provides a spring seat 134 for spring 132. Stanchion 128 and stop 130 are fixedly in position and not intended to move.

Housing 110 includes supports 140 and 142 that function to rotatably support a lead screw. In the illustrated embodiment, two lead screws 144 are employed about 180 degrees apart from one another. Each lead screw 144 is driven by a drive member 150 that may be a belt or chain, or may be substituted by a gear drive arrangement, etc. The drive members 150 are in operable communication with motor shaft 124 (via V-groove in this depiction) so that rotary movement from the motor is transmitted to the drive members 150 and thereby the lead screws 144.

Mounted to each lead screw 144 is a follower 152. The follower may be a single component in annular form to engage both lead screws as illustrated or may be individual components, one on each lead screw. The purpose of follower(s) 152 is to support magnet(s) 154 to hold a stem head 156 when power is supplied. By magnetically (e.g., electro-magnetically) attaching stem head 156 to follower(s) 152, the lead screws 144 are in a position to actuate the drive stem 118 to an open position as shown in FIG. 4. In this position the actuator has caused the valve to open. To assist in maintaining that position and to avoid back driving of lead screws 144, a second electro-magnetic hold down 148 is provided in an extension 146 of supports 142. This electro-magnet hold down 148 is also on the same power feed as the other electro-magnets and so will fail-safe as well. Upon loss of electrical power either intentionally or unintentionally, the magnetic field generated by magnets 154 will be lost thereby leaving nothing to inhibit the biasing action of spring 121 from moving the drive stem 118. Following release of the magnetic field and spring 121 action, the actuator will be in the position shown in FIG. 3. In order to reopen the actuator, the motor is run in reverse, thereby moving follower(s) 152 toward motor 126; reinitiating power and thereby generating a magnetic field at magnets 154. This in turn attracts stem head 156 sufficiently to allow follower(s) 152 to urge the drive stem 118 into the open position against the spring force of spring 121. The actuator is inherently fail-safe as is the foregoing embodiment, does not require hydraulic fluid and eliminates the need for space occupying supporting infrastructure on the rig.

While preferred embodiments have been shown and described, modifications and substitutions may be made thereto without departing from the spirit and scope of the invention. Accordingly, it is to be understood that the present invention has been described by way of illustrations and not limitation.

What is claimed is:

1. An electromagnetic valve actuator comprising:
a housing;
a drive stem extending from the housing; and
an electro-magnet in operable communication with the housing and drive stem, the drive stem being responsive to a magnetic field generated by the electro-magnet.

2. An electro-magnetic valve actuator as claimed in claim 1 wherein one of the drive stem and the housing carries the electromagnet.

3. An electromagnetic valve actuator as claimed in claim 2 wherein the other of the drive stem and the housing carries a permanent magnet in operable communication with the magnetic field of the electro-magnet when generated.

4. An electro-magnetic valve actuator as claimed in claim 2 wherein the other of the drive stem and the housing also carries an electromagnet.

5. An electro-magnetic valve actuator as claimed in claim 1 wherein the housing further comprises a hold-open magnet.

6. An electro-magnetic valve actuator as claimed in claim 5 wherein the hold-open magnet is an electro-magnet.

7. An electromagnetic valve actuator as claimed in claim 5 wherein the actuator includes a biasing member to urge the drive stem to a closed position and against which biasing member the hold-open magnet acts.

8. An electro-magnetic-mechanical valve actuator comprising:
a housing;
a drive stem having a stem head extending from the housing;
a lead screw supported by the housing;
a motor in driving communication with the lead screw; and
a follower in threaded communication with the lead screw, the follower selectively electro-magnetically affixable to the stem head.

9. An electro-magnetic-mechanical valve actuator as claimed in claim 8 wherein at least one of the stem head and the follower includes an electromagnet and the other of which includes one of a permanent magnet, an electro-magnet and a magnetic material.

10. An electro-magnetic-mechanical valve actuator as claimed in claim 8 wherein the housing further includes a member selectively electro-magnetically affixable to the follower.

11. An electro-magnetic-mechanical valve actuator as claimed in claim 10 wherein the member acts against a biasing member that biases the drive stem toward the closed position.

12. A method for operating a valve actuator comprising:
applying a current to an electro-magnet to urge a drive stem against a closure spring to open the valve; and
maintaining current in the electro-magnet to keep the valve in the open position.

13. A method for operating a valve actuator as claimed in claim 12 wherein the method further includes removing current from the electromagnet to allow the valve to close.

14. A method for operating a valve actuator as claimed in claim 13 wherein removing current includes both intentional and unintentional removal.

15. A method for operating a valve actuator as claimed in claim 12 wherein the method includes engaging a mechanical assembly to open the drive stem.

16. A method for operating a valve actuator as claimed in claim 12 wherein the method further includes applying a current to a hold-open electro-magnet.
